(19) United States
(12) Patent Application Publication
(10) Pub. No.: US 2014/0240351 A1
(43) Pub. Date: Aug. 28, 2014

(54) MIXED REALITY AUGMENTATION

(71) Applicants: Michael Scavezze, Bellevue, WA (US); Nicholas Gervase Fajt, Seattle, WA (US); Arnulfo Zepeda Navratil, Kirkland, WA (US); Jason Scott, Kirkland, WA (US); Adam Benjamin Smith-Kipnis, Seattle, WA (US); Brian Mount, Seattle, WA (US); John Bevis, Seattle, WA (US); Cameron Brown, Redmond, WA (US); Tony Ambrus, Seattle, WA (US); Phillip Charles Heckinger, Woodinville, WA (US); Dan Kroymann, Kirkland, WA (US); Matthew G. Kaplan, Seattle, WA (US); Aaron Krauss, Snoqualmie, WA (US)

(72) Inventors: Michael Scavezze, Bellevue, WA (US); Nicholas Gervase Fajt, Seattle, WA (US); Arnulfo Zepeda Navratil, Kirkland, WA (US); Jason Scott, Kirkland, WA (US); Adam Benjamin Smith-Kipnis, Seattle, WA (US); Brian Mount, Seattle, WA (US); John Bevis, Seattle, WA (US); Cameron Brown, Redmond, WA (US); Tony Ambrus, Seattle, WA (US); Phillip Charles Heckinger, Woodinville, WA (US); Dan Kroymann, Kirkland, WA (US); Matthew G. Kaplan, Seattle, WA (US); Aaron Krauss, Snoqualmie, WA (US)

(21) Appl. No.: 13/779,614

(22) Filed: Feb. 27, 2013

(51) Int. Cl. G06T 19/00

(52) U.S. Cl. CPC G06T 19/006
USPC 345/633

(57) ABSTRACT

Embodiments that relate to providing motion amplification to a virtual environment are disclosed. For example, in one disclosed embodiment a mixed reality augmentation program receives from a head-mounted display device motion data that corresponds to motion of a user in a physical environment. The program presents via the display device the virtual environment in motion in a principal direction, with the principal direction motion being amplified by a first multiplier as compared to the motion of the user in a corresponding principal direction. The program also presents the virtual environment in motion in a secondary direction, where the secondary direction motion is amplified by a second multiplier as compared to the motion of the user in a corresponding secondary direction, and the second multiplier is less than the first multiplier.

### BACKGROUND

Augmented or mixed reality experiences may take place in large virtual worlds, such as cities, landscapes, battlefields, etc. Some mixed reality devices and experiences may allow a user to employ real world physical movement as a means of traversing the virtual world. However, directly mapping the real world physical movement of a mixed reality participant to virtual motion in such a large virtual world may present several challenges.

For example, a large virtual world may present a user with kilometers of virtual terrain, perhaps even hundreds or thousands of kilometers, to traverse. Such an expanse of virtual terrain may be much larger than can be conveniently covered via direct mapping of physical movement of the user without the user becoming tired or bored. In some examples, where a user's available real world space is smaller than the virtual world the user is experiencing, the user will encounter a physical object in the real world, such as a wall of a room, that prevents the user from traversing further in that direction of the virtual world. Additionally, in such situations a user immersed in the mixed reality experience may not notice the physical wall, and may inadvertently contact the wall and receive to an unwelcome surprise.

### SUMMARY

Various embodiments are disclosed herein that relate to motion amplification in a mixed reality environment. For example, one disclosed embodiment provides a method for providing motion amplification to a virtual environment in a mixed reality environment. The method includes receiving from a head-mounted display device motion data that corresponds to motion of a user in a physical environment. The virtual environment is presented in motion in a principal direction via the head-mounted display device, with the principal direction motion being amplified by a first multiplier as compared to the motion of the user in a corresponding principal direction. The virtual environment is also presented in motion in a secondary direction via the head-mounted display device, with the secondary direction motion being amplified by a second multiplier as compared to the motion of the user in a corresponding secondary direction, where the second multiplier is less than the first multiplier.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view of a mixed reality augmentation system according to an embodiment of the present disclosure.

FIG. 2 shows an example head-mounted display device according to an embodiment of the present disclosure.

FIG. 3 is a schematic perspective view of a user wearing the head-mounted display device of FIG. 2 and walking in a room from an initial position to a subsequent position.

FIG. 4 is a schematic top view of the user of FIG. 3 showing the user's motion from the initial position to the subsequent position.

FIG. 5 is a schematic view of a virtual environment as seen by the user through the head-mounted display device at the initial position of FIG. 4.

FIG. 6 is schematic top view of the virtual environment of FIG. 5.

FIG. 7 is a schematic view of a virtual environment as seen by the user through the head-mounted display device at the subsequent position of FIG. 4.

FIG. 8 is schematic top view of the virtual environment of FIG. 7.

FIG. 9 is a schematic view of the virtual environment of FIG. 5 scaled down.

FIG. 10 is a schematic view of a user in a mixed reality environment that includes an initial virtual scene and a virtual portal leading to another virtual scene.

FIG. 11 is a schematic top view of the initial virtual scene and the virtual portal.

FIG. 12 is a schematic top view of the subsequent virtual scene and the virtual portal.

FIGS. 13A, 13B and 13C are a flow chart of a method for providing motion amplification to a virtual environment in a mixed reality environment according to an embodiment of the present disclosure.

FIG. 14 is a simplified schematic illustration of an embodiment of a computing device.

### DETAILED DESCRIPTION

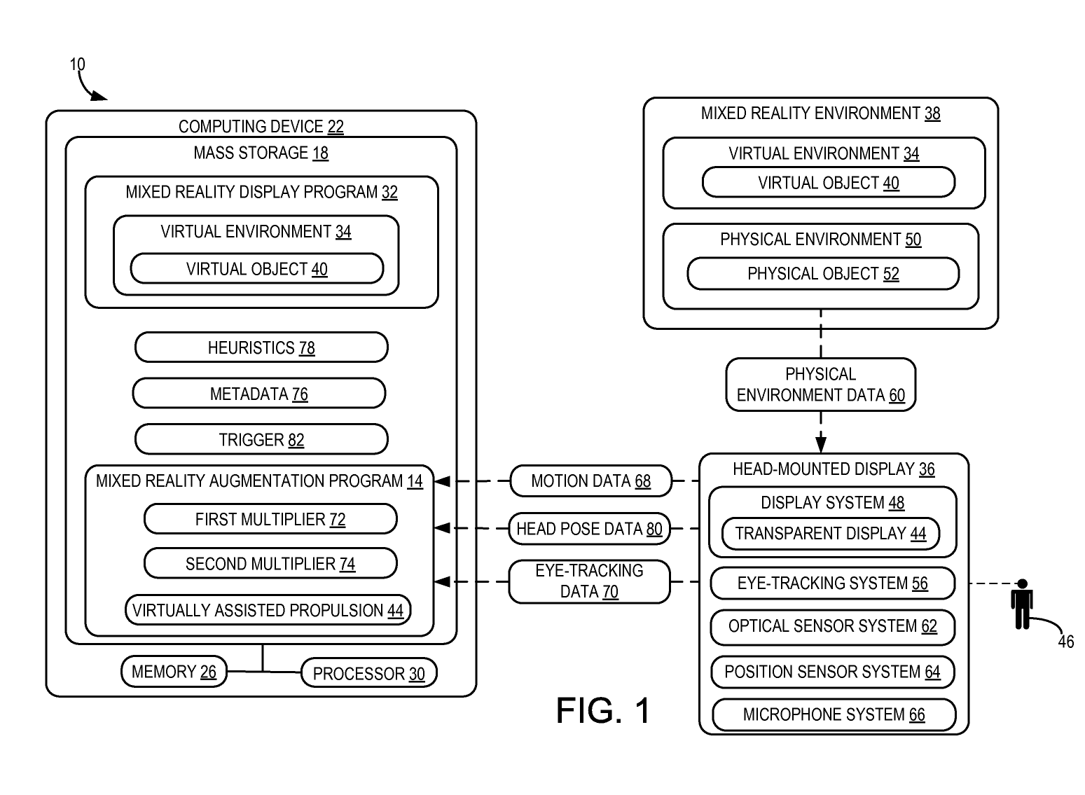

FIG. 1 shows a schematic view of one embodiment of a mixed reality augmentation system 10. The mixed reality augmentation system 10 includes a mixed reality augmentation program 14 that may be stored in mass storage 18 of a computing device 22. The mixed reality augmentation program 14 may be loaded into memory 26 and executed by a processor 30 of the computing device 22 to perform one or more of the methods and processes described in more detail below.

The mixed reality augmentation system 10 includes a mixed reality display program 32 that may generate a virtual environment 34 for display on a display device, such as the head-mounted display (HMD) device 36, to create a mixed reality environment 38. The virtual environment 34 includes one or more virtual objects 40. Such virtual objects 40 may include one or more virtual images, such as three-dimensional holographic images and other virtual objects, such as two-dimensional virtual objects.

The computing device 22 may take the form of a desktop computing device, a mobile computing device such as a smart phone, laptop, notebook or tablet computer, network computer, home entertainment computer, interactive television, gaming system, or other suitable type of computing device. Additional details regarding the components and computing aspects of the computing device 22 are described in more detail below with reference to FIG. 14.

The computing device 22 may be operatively connected with the HMD device 36 using a wired connection, or may employ a wireless connection via WiFi, Bluetooth, or any other suitable wireless communication protocol. Additionally, the example illustrated in FIG. 1 shows the computing device 22 as a separate component from the HMD device 36. It will be appreciated that in other examples the computing device 22 may be integrated into the HMD device 36.

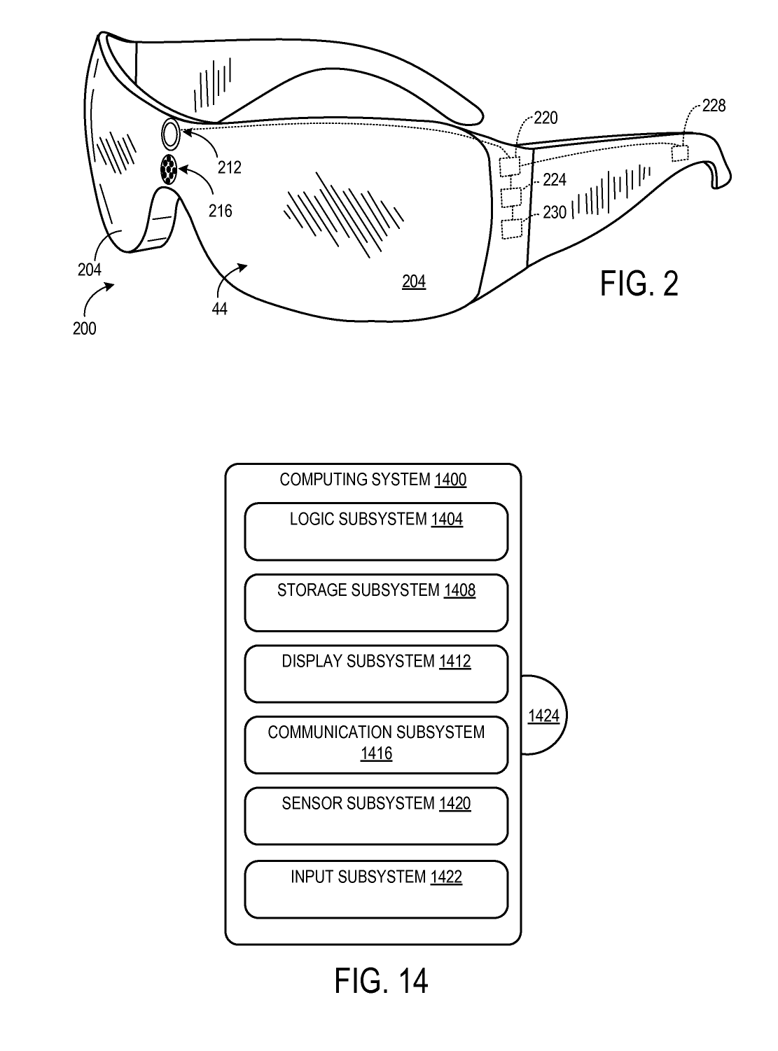

With reference now also to FIG. 2, one example of an HMD device 200 in the form of a pair of wearable glasses with a transparent display 44 is provided. It will be appreciated that in other examples, the HMD device 200 may take other suitable forms in which a transparent, semi-transparent or non-transparent display is supported in front of a viewer's eye or eyes. It will also be appreciated that the HMD device 36 shown in FIG. 1 may take the form of the HMD device 200, as described in more detail below, or any other suitable HMD device. Additionally, many other types and configurations of display devices having various form factors may also be used within the scope of the present disclosure. Such display devices may include, but are not limited to, hand-held smart phones, tablet computers, and other suitable display devices.

With reference to FIGS. 1 and 2, in this example the HMD device 36 includes a display system 48 and transparent display 44 that enables images such as holographic objects to be delivered to the eyes of a user 46. The transparent display 44 may be configured to visually augment an appearance of a physical environment 50, including one or more physical objects 52, to a user 46 viewing the physical environment through the transparent display. For example, the appearance of the physical environment 50 may be augmented by graphical content (e.g., one or more pixels each having a respective color and brightness) that is presented via the transparent display 44 to create a mixed reality environment 38.

The transparent display 44 may also be configured to enable a user to view a physical, real-world object 52 in the physical environment 50 through one or more partially transparent pixels that are displaying a virtual object representation. In one example, the transparent display 44 may include image-producing elements located within lenses 204 (such as, for example, a see-through Organic Light-Emitting Diode (OLED) display). As another example, the transparent display 44 may include a light modulator on an edge of the lenses 204. In this example the lenses 204 may serve as a light guide for delivering light from the light modulator to the eyes of a user. Such a light guide may enable a user to perceive a 3D holographic image located within the physical environment 50 that the user is viewing, while also allowing the user to view physical objects 52 in the physical environment, thus creating a mixed reality environment 38.

As another example, the transparent display 44 may include one or more opacity layers in which blocking images may be generated. The one or more opacity layers may selectively block real-world light received from the physical environment 50 before the light reaches an eye of a user 46 wearing the HMD device 36. By selectively blocking real-world light, the one or more opacity layers may enhance the visual contrast between a virtual object 40 and the physical environment 50 within which the virtual object is perceived by the user.

The HMD device 36 may also include various sensors and related systems. For example, the HMD device 36 may include an eye-tracking sensor system 56 that utilizes at least one inward facing sensor 216. The inward facing sensor 216 may be an image sensor that is configured to acquire image data in the form of eye-tracking information from a user's eyes. Provided the user has consented to the acquisition and use of this information, the eye-tracking sensor system 56 may use this information to track a position and/or movement of the user's eyes.

The HMD device 36 may also include sensor systems that receive physical environment data 60 from the physical environment 50. For example, the HMD device 36 may include an optical sensor system 62 that utilizes at least one outward facing sensor 212, such as an optical sensor. Outward facing sensor 212 may detect movements within its field of view, such as gesture-based inputs or other movements performed by a user 46 or by a person or physical object within the field of view. Outward facing sensor 212 may also capture two-dimensional image information and depth information from physical environment 50 and physical objects 52 within the environment. For example, outward facing sensor 212 may include a depth camera, a visible light camera, an infrared light camera, and/or a position tracking camera.

The HMD device 36 may include depth sensing via one or more depth cameras. In one example, each depth camera may include left and right cameras of a stereoscopic vision system. Time-resolved images from one or more of these depth cameras may be registered to each other and/or to images from another optical sensor such as a visible spectrum camera, and may be combined to yield depth-resolved video.

In other examples a structured light depth camera may be configured to project a structured infrared illumination, and to image the illumination reflected from a scene onto which the illumination is projected. A depth map of the scene may be constructed based on spacings between adjacent features in the various regions of an imaged scene. In still other examples, a depth camera may take the form of a time-of-flight depth camera configured to project a pulsed infrared illumination onto a scene and detect the illumination reflected from the scene. It will be appreciated that any other suitable depth camera may be used within the scope of the present disclosure.

Outward facing sensor 212 may capture images of the physical environment 50 in which a user 46 is situated. In one example, the mixed reality display program 32 may include a 3D modeling system that uses such input to generate the virtual environment 34 that models the physical environment 50 surrounding the user 46.

The HMD device 36 may also include a position sensor system 64 that utilizes one or more motion sensors 224 to enable motion detection, position tracking and/or orientation sensing of the HMD device. For example, the position sensor system 64 may be utilized to determine a direction, velocity and acceleration of a user's head. The position sensor system 64 may also be utilized to determine a head pose orientation of a user's head. In one example, position sensor system 64 may comprise an inertial measurement unit configured as a six-axis or six-degree of freedom position sensor system. This example position sensor system may, for example, include three accelerometers and three gyroscopes to indicate or measure a change in location of the HMD device 36 within three-dimensional space along three orthogonal axes (e.g., x, y, z), and a change in an orientation of the HMD device about the three orthogonal axes (e.g., roll, pitch, yaw).

Position sensor system 64 may also support other suitable positioning techniques, such as GPS or other global navigation systems. Further, while specific examples of position sensor systems have been described, it will be appreciated that other suitable position sensor systems may be used.

In some examples, motion sensors 224 may also be employed as user input devices, such that a user may interact with the HMD device 36 via gestures of the neck and head, or even of the body. The HMD device 36 may also include a microphone system 66 that includes one or more microphones 220. In other examples, audio may be presented to the user via one or more speakers 228 on the HMD device 36.

The HMD device 36 may also include a processor 230 having a logic subsystem and a storage subsystem, as discussed in more detail below with respect to FIG. 14, that are in communication with the various sensors and systems of the HMD device. In one example, the storage subsystem may include instructions that are executable by the logic subsystem to receive signal inputs from the sensors and forward such inputs to computing device 22 (in unprocessed or processed form), and to present images to a user via the transparent display 44.

It will be appreciated that the HMD device 36 and related sensors and other components described above and illustrated in FIGS. 1 and 2 are provided by way of example. These examples are not intended to be limiting in any manner, as any other suitable sensors, components, and/or combination of sensors and components may be utilized. Therefore it is to be understood that the HMD device 36 may include additional and/or alternative sensors, cameras, microphones, input devices, output devices, etc. without departing from the scope of this disclosure. Further, the physical configuration of the HMD device 36 and its various sensors and subcomponents may take a variety of different forms without departing from the scope of this disclosure.

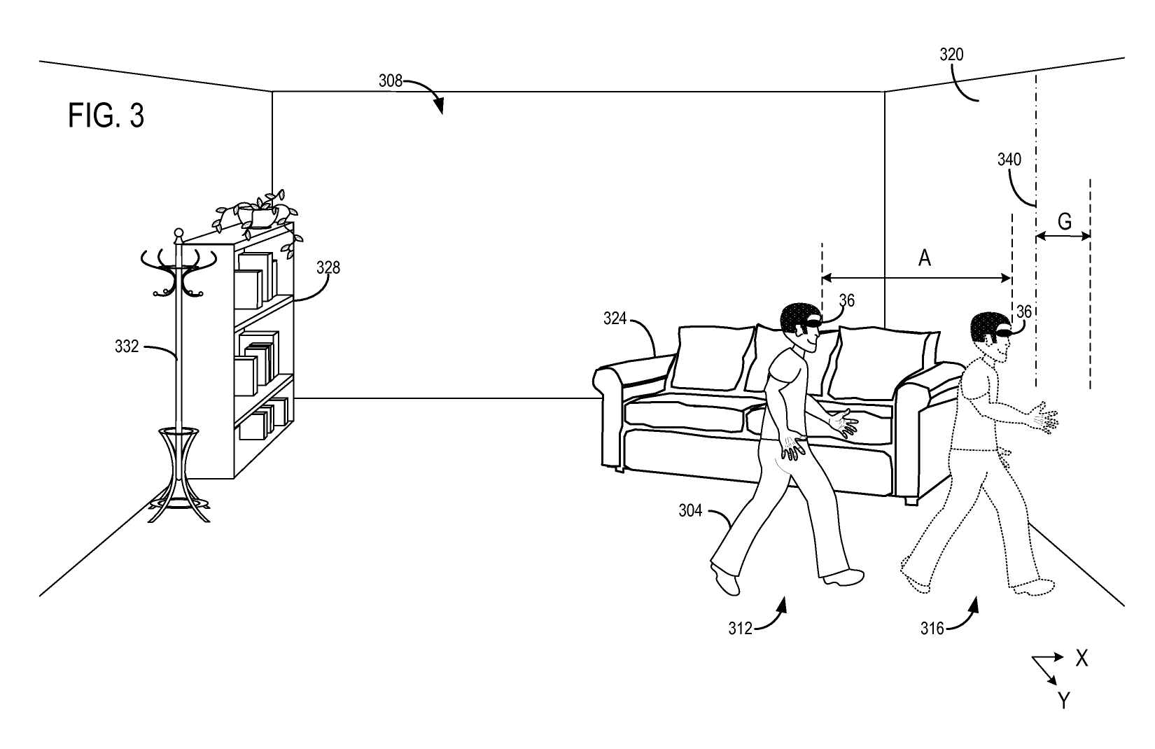

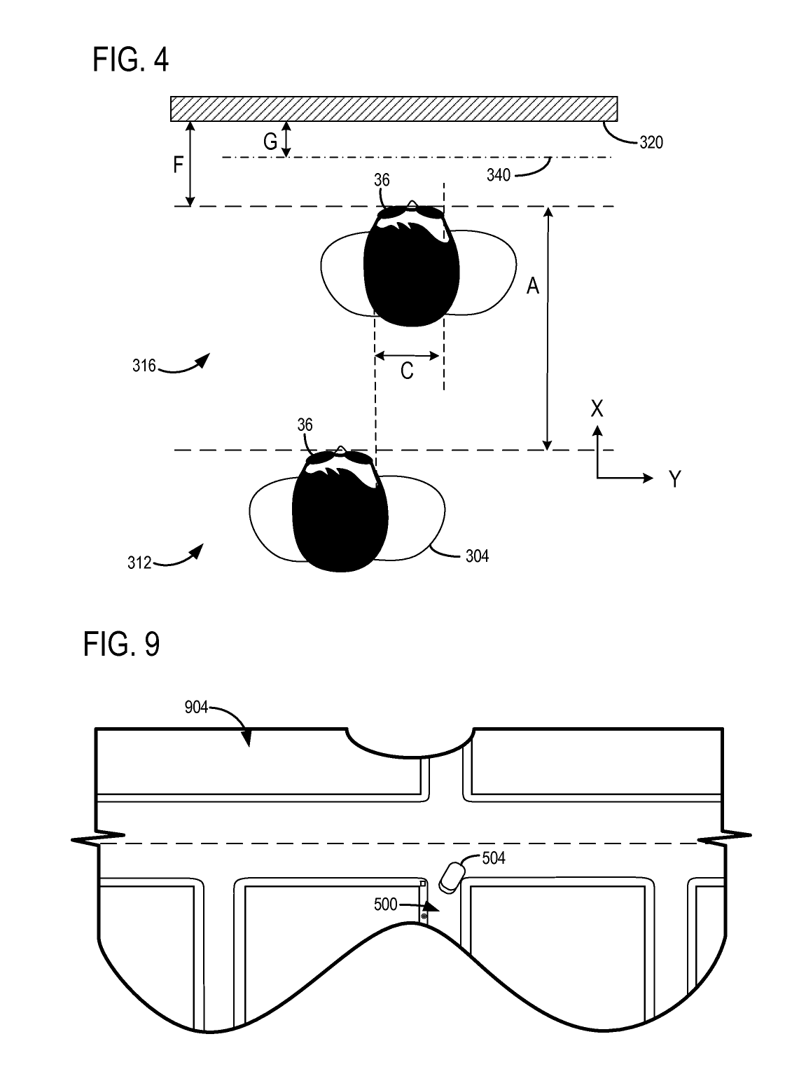

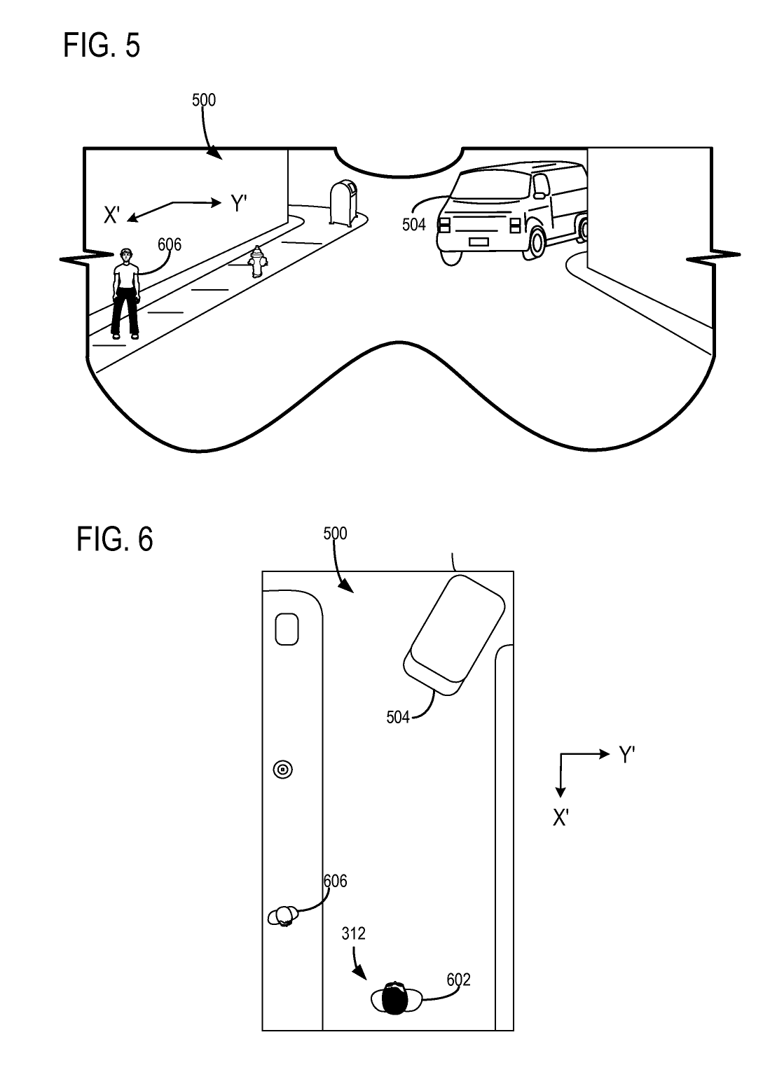

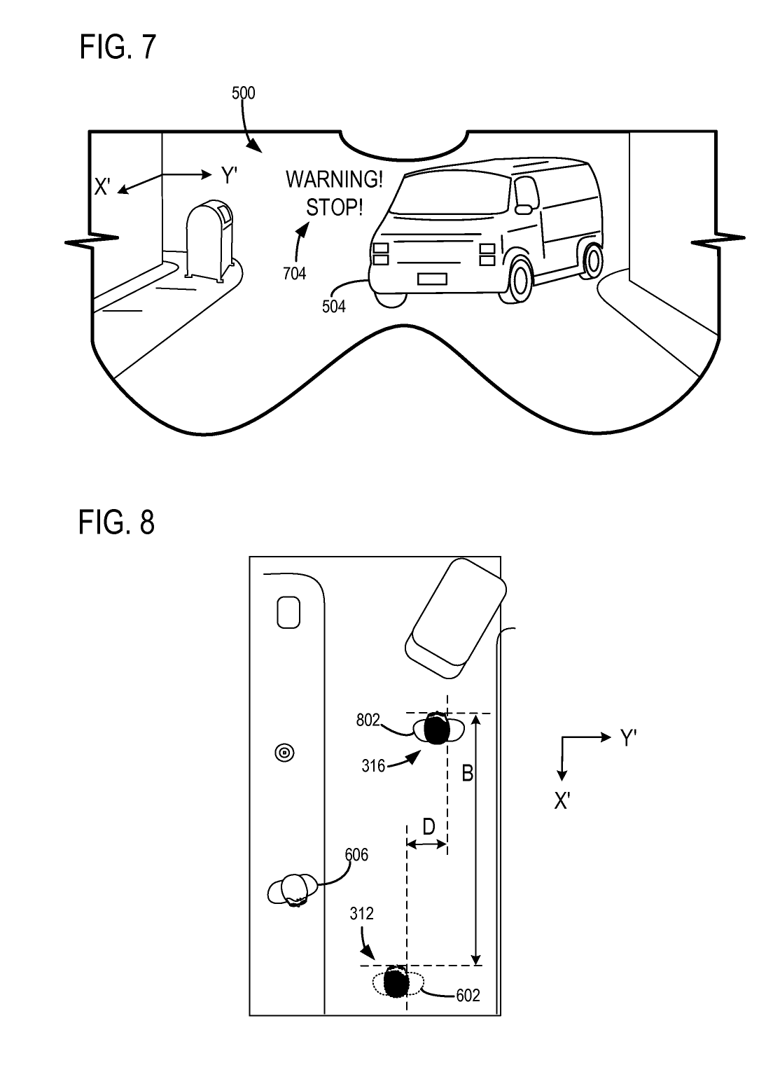

With reference now to FIGS. 3-12, descriptions of example use cases and embodiments of the mixed reality augmentation system 10 will now be provided. FIGS. 3-8 provide various schematic illustrations of a user 304 located in a living room 308 and experiencing a mixed reality environment via an HMD device 36 in the form of HMD device 200. Briefly, FIG. 3 shows the user in motion from an initial position 312 to a subsequent position 316 in the living room 308. FIG. 4 shows a schematic top view of the user 304 of FIG. 3 moving from the initial position 312 to the subsequent position 316. FIG. 5 is a schematic view of a virtual environment in the form of an alley 500 and van 504 as seen by the user 304 through the HMD device 36 at the initial position 312. FIG. 7 is a schematic view of the virtual alley 500 and van 504 as seen by the user through the HMD device 36 at the subsequent position 316.

As viewed by the user 46, the virtual environment 34 may combine with the physical environment 50 of the living room 308 to create a mixed reality environment 38. In one example and as discussed above, one or more opacity layers in the HMD device 36 may be utilized to provide a dimming effect to physical objects 52 in the living room 308, such as the wall 320, couch 324, bookcase 328 and coat rack 332. In this manner, the virtual alley 500, van 504 and other virtual objects 40 of the virtual environment 34 may be more clearly seen and may appear more realistic to the user 304.

It will be appreciated that the magnitude of such dimming effect may vary among a 100% dimming effect, whereby the physical objects are not visible, a partial dimming effect, whereby the physical objects are partially visible, and a zero dimming effect. In one example, a 100% dimming effect may result in only virtual objects 40 in the virtual environment 34 being visible to the user. In another example, a zero dimming effect may result in substantially all light from physical objects 52 in the physical environment 50 being transmitted through the transparent display 44.

With reference now to FIGS. 3 and 4, the user 304 may walk from the initial position 312 to the subsequent position 316 in a principal direction X toward the wall 320. The user may traverse a distance A in the principal direction X between the initial position 312 and the subsequent position 316. As the user 304 is walking in the principal direction X, the user 304 may also move laterally in a secondary direction Y that is orthogonal to the principal direction X. In the example shown in FIG. 4, the user 304 moves a distance C in the secondary direction Y between the initial position 312 and the subsequent position 316. As the user 304 is moving, the mixed reality augmentation program 14 receives motion data 68 from the HMD device 36 that corresponds to the motion of the user in the living room 308.

Using the motion data 68, the mixed reality augmentation program 14 presents the virtual environment including the alley 500 and van 504 in motion relative to user 304 in a manner corresponding to the actual movement of the user in the living room 308. Advantageously and as explained in more detail below, the mixed reality augmentation program 14 may amplify the motion of the virtual environment as presented to the user 304 via the mixed reality display program 32 and display system 48.

At the initial position 312, the user is presented with a view of the virtual alley 500 as shown in FIG. 5. In this position, the virtual van 504 is presented at a first distance from the user's initial viewpoint 602 in the virtual environment (see FIG. 6), such as for example 15 meters away from the user's viewpoint. FIG. 6 shows a top view of the virtual alley 500 and illustrates the user's initial viewpoint 602 of the virtual environment when the user 304 is in the initial position 312.

With reference also to FIG. 4, in the room 308 the user 304 may advance a distance A in the principal direction X from the initial position 312 to the subsequent position 316. As the user 304 traverses the distance A toward the subsequent position 316, the alley 500 is presented in motion that both corresponds to the user's motion and is amplified with respect to the user's motion.

More particularly and with reference to FIG. 5, as the user 304 moves from the initial position 312 to the subsequent position 316, the alley 500 is presented in motion in a principal direction X′ that corresponds to the principal direction X of the user's actual movement. With reference to FIGS. 3 and 5, in this example it will be appreciated that the principal direction X′ in the virtual environment 34 is opposite to the corresponding principal direction X of the user 304 in the physical environment 50. In this manner, as the user 304 walks forward in principal direction X the virtual alley 500 moves toward the user's initial viewpoint 602 in the direction X′, thereby creating the perception of the user advancing toward the virtual van 504.

Additionally, to improve the user's ability to cover larger distances in the virtual environment, the mixed reality augmentation program 14 amplifies the motion of the virtual environment as presented to the user 304 via the mixed reality display program 32 and display system 48. In one example, and with reference to FIGS. 7 and 8, the mixed reality augmentation program 14 amplifies the principal direction X′ motion of the virtual alley 500 by a first multiplier 72 as compared to the actual motion of the user in the corresponding principal direction X. The first multiplier 72 may be any value greater than 1 including, but not limited to, 2, 5, 10, 50 100, 1000, or any other suitable value. It will also be appreciated that in other examples high-precision motion may be desirable. In these examples, the mixed reality augmentation program 14 may de-amplify the motion of the virtual environment as presented to the user 304 via the mixed reality display program 32 and display system 48. Accordingly in these examples, the first multiplier 72 may have a value less than 1.

FIG. 8 shows a top view of the virtual alley 500 and illustrates the user's subsequent viewpoint 802 of the virtual environment when the user 304 is in the subsequent position 316. In the virtual environment, the user's viewpoint has advanced by a virtual distance B that is greater than the corresponding distance A of the actual movement of the user 304 in the room 308. In one example, the user 304 may move in the principal direction X by a distance of A=1 meter, while the virtual environment may be presented in amplified motion in the corresponding principal direction X′ such that the user's viewpoint covers a distance of B=10 meters, representing a multiplier of 10.

In moving from the initial position 312 to the subsequent position 316, the user 304 may also move in one or more additional directions. For example and with reference to FIG. 4, the user 304 may move sideways in a secondary direction Y while advancing to the subsequent position 316. It will also be appreciated that such movement may not be linear and may vary between the initial position 312 and the subsequent position 316. For example, the user's head and/or body may sway slightly back and forth as the user moves. Correspondingly, the virtual environment will be presented in corresponding back and forth motion as the user's viewpoint advances in the virtual environment.

It has been discovered that in some examples, certain amplifications of motion of a virtual environment in such a secondary direction can cause an unpleasant mixed reality experience for a user. For example, where a user is walking forward with slight side-to-side head motion, significantly amplifying such side-to-side motion in a corresponding virtual environment presentation can create dizziness and/or instability in the user.

Accordingly and with reference again to FIGS. 4 and 8, in some embodiments the mixed reality augmentation program 14 amplifies the secondary direction Y′ motion of the virtual environment by a second multiplier 74 as compared to the motion of the user in the corresponding secondary direction Y. Additionally, the mixed reality augmentation program 14 selects the second multiplier 74 to be less than the first multiplier 72. The second multiplier 74 may be any value less than the first multiplier 72 including, but not limited to, 1, 1.5, 2, or any other suitable value. In some examples, the second multiplier 74 may be less than 1, such as 0.5, 0 or other positive value less than 1.

In one example as shown in FIG. 4, between the initial position 312 and the subsequent position 316 the user 304 may move in the secondary direction Y a distance C. With reference to FIG. 8, as the user viewpoint moves to the subsequent position 316, the motion of the virtual environment in the corresponding secondary direction Y′ may equate to a distance D that is slightly larger than the corresponding actual distance C in the secondary direction Y. For example, the distance D may be the result of the distance C being amplified by a multiplier of 1.5, while the distance B may be the result of the distance A being amplified by a multiplier of 10.

Advantageously, by utilizing a second multiplier 74 for amplification of the secondary direction motion that is less than the first multiplier 72 of the principal direction motion, the mixed reality augmentation program 14 may provide amplification of a user's motion in principal and secondary directions, while also minimizing unpleasant user experiences associated with over-amplification of the user's motion in the secondary direction.

In one example, the mixed reality augmentation program 14 may be configured to select the first multiplier 72 and the second multiplier 74 based on an orientation of the user's principal direction with respect to the virtual environment. With reference to FIGS. 4 and 6, in one example the motion of the user 304 in the principal direction X may correspond to the motion of the virtual environment in the corresponding principal direction X′. From the users' initial viewpoint 602, and given the motion of the virtual environment in the corresponding principal direction X′, there is ample open space in the virtual environment in front of the user's viewpoint along the direction X′.

Accordingly, the mixed reality augmentation program 14 may select a first multiplier 72, such as 10 for example, that will enable the user 304 to traverse space in the virtual environment at a significantly amplified rate as compared to the actual movement of the user in the room 308. In this manner, the first multiplier 72 may be based on the orientation of the user's principal direction with respect to the virtual environment. It will also be appreciated that the mixed reality augmentation program 14 may use a similar process to select the second multiplier 74 based on the orientation of the user's secondary direction with respect to the virtual environment.

In another example, the mixed reality augmentation program 14 may be configured to select the first multiplier 72 and the second multiplier 74 based on eye-tracking data 70 and/or head pose data 80 received from the HMD device 36. With reference to FIG. 6, in one example the user's head may be rotated such that the user's initial viewpoint 602 in the virtual environment is facing toward the side of the alley 500 and at the pedestrian 606. Where the virtual environment is in motion in the principal direction X′, a first multiplier of a relatively lower value, such as 3, may be selected based on an inference that the user's attention is in a direction other than the principal direction.

Similarly, in another example the eye-tracking data 70 may indicate that the user 304 is gazing at the pedestrian 606. Where the virtual environment is in motion in the principal direction X′, a first multiplier 72 of a relatively lower value may again be selected based on an inference that the user's attention is in a direction other than the principal direction.

In another example, the mixed reality augmentation program 14 may be configured to select the first multiplier 72 and the second multiplier 74 based on a velocity of the user 304. In one example where the user 304 is moving in the principal direction X at a velocity of 1.0 m/s, a first multiplier 72 of 3 may be selected. If the user's velocity increases to 2.0 m/s, the first multiplier 72 may be revised to a larger value, such as 6, to reflect the user's increased velocity and enable the user to traverse more virtual space in the virtual environment. Values for the second multiplier 74 may be similarly selected based on the user's velocity in the secondary direction Y.

In another example, the mixed reality augmentation program 14 may be configured to select the first multiplier 72 and the second multiplier 74 based on metadata 76 describing a predetermined level of amplification. In one example, a developer of the virtual environment including the virtual alley 500 may provide metadata 76 that determines values for the first multiplier 72 and the second multiplier 74. For example, such metadata 76 may base the values of the first multiplier 72 and second multiplier 74 on one or more conditions or behaviors of the user 304 relative to the virtual environment. It will be appreciated that various other examples of metadata describing a predetermined level of amplification for the first multiplier 72 and the second multiplier 74 may also be utilized and are within the scope of the present disclosure.

In another example, the mixed reality augmentation program 14 may be configured to select the first multiplier 72 and the second multiplier 74 utilizing heuristics 78 based on characteristics of the virtual environment 34 and/or the physical environment 50. In this manner, the mixed reality augmentation program 14 may help users to travel more efficiently toward their intended destinations in a virtual environment, even if users are less skilled at aligning themselves in the virtual environment.

In one example of utilizing heuristics, where the user is virtually walking down the virtual alley 500, motion may be amplified in the principal direction X′ parallel to the alley, while motion may not be amplified in the secondary direction Y′ toward the walls of the alley. In another example, where a user is experiencing a virtual environment in a relatively smaller physical area, such as a cubicle measuring 3 meters wide by 3 meters long, motion may be amplified in the principal direction X′ by a greater multiple as compared to the user experiencing the virtual environment in a large open park setting.

In another example, the mixed reality augmentation program 14 may be configured to decouple the presentation of the virtual environment from the motion of the user upon the occurrence of a trigger 82. Alternatively expressed, the presentation of the virtual environment may be selectively frozen such that the user's view and experience of the virtual environment remains fixed regardless of the user's continued motion. The trigger that invokes such a decoupling of the virtual environment from user motion may be activated programmatically or by user selection.

With reference to FIGS. 3 and 4, in one example the user 304 may be in subsequent position 316 in which the wall 320 is a distance F away from the HMD device 36. For example, the distance F may by 0.5 m. The user 304 may be participating in a virtual hiking experience and may desire to continue hiking along 1 km. of virtual trail that extends in a direction corresponding to the principal direction X of FIG. 4. In this case, the user 304 may freeze the virtual hiking environment presentation, turn around in the room 308 to face more open space, unfreeze the virtual hiking environment, and walk toward the coat rack 332 so as to continue hiking along the virtual trail. It will be appreciated that the user may decouple the virtual hiking environment from user motion and subsequently reengage the virtual environment by any suitable user input mechanism such as, for example, voice activation.

In another example the trigger for decoupling of the virtual environment from user motion may be activated programmatically. In one example the mixed reality augmentation program 14 may generate a virtual boundary 340 in the form of a plane extending parallel to the wall 320 at a distance G from the wall. The trigger may comprise the HMD device 36 crossing the virtual boundary 340, at which point the virtual environment is decoupled from and frozen with respect to further motion of the user. Advantageously, in this example the mixed reality augmentation program 14 conveniently freezes the virtual environment when the user's location in the physical environment restricts user advancement in the virtual environment. It will be appreciated that any suitable distance G may be utilized including, but not limited to, 0.5 m, 1.0 m, 2.0 m, etc.

In another example, the mixed reality augmentation program 14 may provide a notification via the HMD device 36 when the HMD device 36 crosses a boundary in the physical environment. In one example and with reference to FIG. 4, the mixed reality augmentation program 14 may display a warning notice to the user 304 when the HMD device 36 worn by the user crosses the virtual boundary 340. An example of such a warning notice 704 is illustrated in FIG. 7. Other examples of notifications include, but are not limited to, audio notifications and other augmentations of the display of the virtual environment. For example, when the HMD device 36 crosses the virtual boundary 340, the mixed reality augmentation program 14 may reduce or eliminate any dimming applied to the user's view of the physical environment 50 to enhance the user's view of objects 52 in the physical environment, such as the wall 320. In another example, the holographic objects in the virtual environment may be dimmed or removed from view to enhance the user's view of objects in the physical environment.

In another example, the mixed reality augmentation program 14 may scale down the presentation of the virtual environment and correspondingly increase the first multiplier 72 such that the principal direction motion is increased. With reference now to FIGS. 5 and 6, in one example the user's view of the virtual environment including virtual alley 500 may be from user's initial viewpoint 602. With reference now to FIG. 9, the mixed reality augmentation program 14 may scale down the presentation of the virtual environment such that the user is presented with a more expansive view of the virtual environment, including portions of the virtual city 904 beyond the virtual alley 500. The mixed reality augmentation program 14 also correspondingly increases the first multiplier 72 such that the principal direction motion in the virtual environment is increased. Advantageously, in this manner the user 304 may more quickly traverse larger sections of the virtual city 904.

In another example, the mixed reality augmentation program 14 may utilize a positioning indicator that is displayed to the user in the virtual environment, and which the user may control to more precisely travel in the virtual environment. For example, a laser-pointer-type indicator comprising a visible red dot may track the user's gaze (via eye-tracking data 70) within the virtual environment. By placing the red dot on a distant object or location in the virtual environment, and then requesting movement to this location, the user 304 may quickly and accurately move the user viewpoint to other locations.

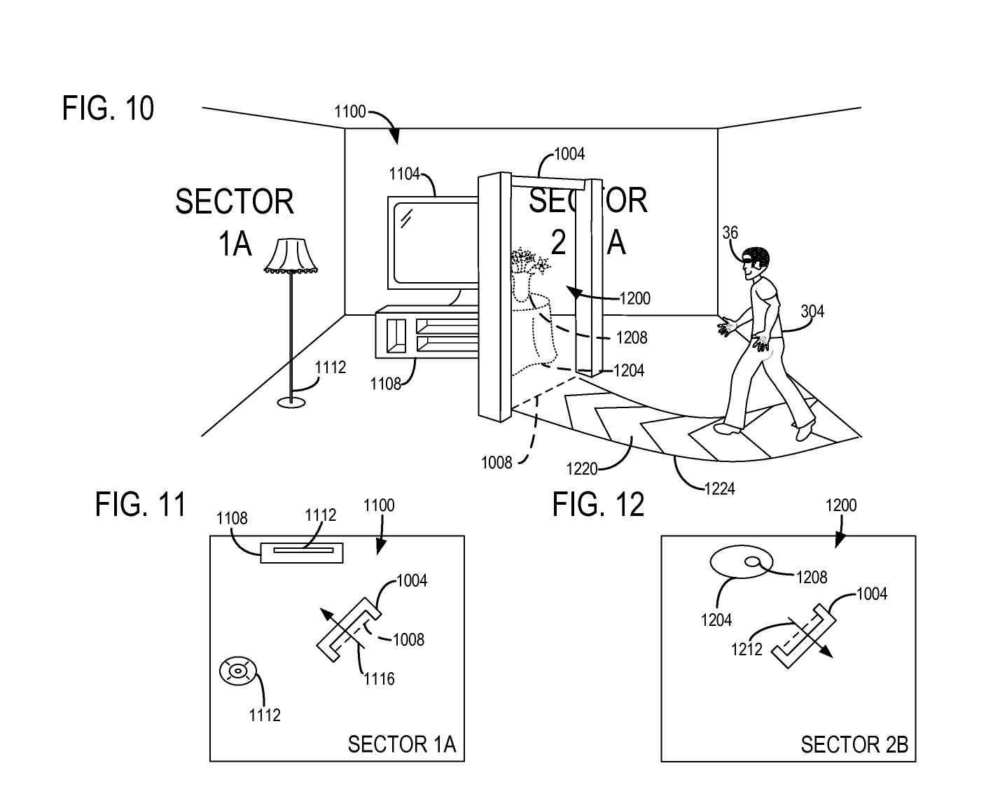

In another example and with reference now to FIGS. 10-12, the mixed reality augmentation program 14 may present another virtual scene via a virtual portal 1004 that represents a virtual gateway from an initial virtual scene the other virtual scene. In the example shown in FIG. 10, the user 304 may be located in a room that includes no other physical objects. As shown in FIGS. 10 and 11, an initial virtual scene 1100 denoted Sector 1A may be generated by the mixed reality augmentation program 14 and may include the virtual portal 1004, a virtual television 1104 on a virtual stand 1108, and a virtual lamp 1112.

As shown in FIG. 12, another virtual scene 1200 denoted Sector 2B may include a virtual table 1204 and vase 1208. With reference again to FIG. 10, the mixed reality augmentation program 14 may present at least a portion of the other virtual scene 1200 that is displayed within the virtual portal 1004. In this manner, when the user 304 looks toward the portal 1004, the user sees the portion of the other virtual scene 1200 visible within the portal, while seeing elements of the initial virtual scene 1100 around the portal.

In another example, when the HMD device 36 worn by the user 304 crosses a plane 1008 of the virtual portal 1004 in the direction of arrow 1116, the mixed reality augmentation program 14 presents via the display system the other virtual scene 1200 via the HMD device 36. Alternatively expressed, when the user 304 crosses the plane 1008 of the virtual portal 1004 in this manner, the user experiences the room as having the virtual table 1204 and vase 1208. After crossing the plane 1008, if the user 304 looks back at the portal 1004 the user sees the portion of the initial virtual scene 1100 visible within the portal, while seeing elements of the other virtual scene 1200 around the portal. Similarly, when the user 304 later crosses plane 1008 of the virtual portal 1004 in the direction of arrow 1212, the mixed reality augmentation program 14 presents via the display system the initial virtual scene 1100 via the HMD device 36.

In another example and with reference to FIG. 10, the mixed reality augmentation program 14 may present a virtual motion translation mechanism, such as a virtual moving conveyor 1220, within the virtual environment. In one example, when the user 304 crosses a boundary of the conveyor 1220, such as a lateral edge 1224, the mixed reality augmentation program presents the initial virtual scene 1100 and the portion of the other virtual scene 1200 viewable in the portal 1004 in motion, as if the user 304 is being carried along the conveyor toward the portal. The user 304 may remain stationary in the physical room while being virtually carried by the conveyor 1220 through the virtual environment. As shown in FIG. 10, the conveyor 1220 may carry the user through the portal 1004 and into the other virtual scene 1200.

It will be appreciated that various other forms and configurations of virtual motion translation mechanisms may be used. Such other forms and configurations include, but are not limited to, elevators, vehicles, amusement rides, capsules, etc.

In another example, the mixed reality augmentation program 14 may continue presenting the virtual environment in motion via a motion translation mechanism while the user 304 moves within the physical environment, provided the user stays within a bounded area of the motion translation mechanism. For example, the user 304 may turn around in place while on the conveyor 1220, thereby realizing views of the virtual environment surrounding the user. In another example, the user may walk along the conveyor 1220 in the direction of travel of the conveyor, thereby increasing the motion of the virtual environment toward and past the user.

In another example, the motion of the user 304 may comprise self-propulsion in the form of walking, running, skipping, hopping, jumping, etc. The mixed reality augmentation program 14 may map the user's self-propulsion to a type of virtually assisted propulsion 86, and correspondingly present the virtual environment in motion that is amplified according to the type of virtually assisted propulsion. In one example, a user's walking or running motion may be mapped to a skating or skiing motion in the virtual environment. In another example, a user's jumping motion covering an actual jumped distance in the physical environment may be significantly amplified to cover a much greater virtual distance in the virtual environment, as compared to the virtual distance covered by a user's walking motion that traverses the same jumped distance. In still other examples, more fanciful types of virtually assisted propulsion 86 may be utilized. For example, a user may throw a virtual rope to the top of a virtual building, physically jump above the physical floor, and virtually swing through the virtual environment via the virtual rope.

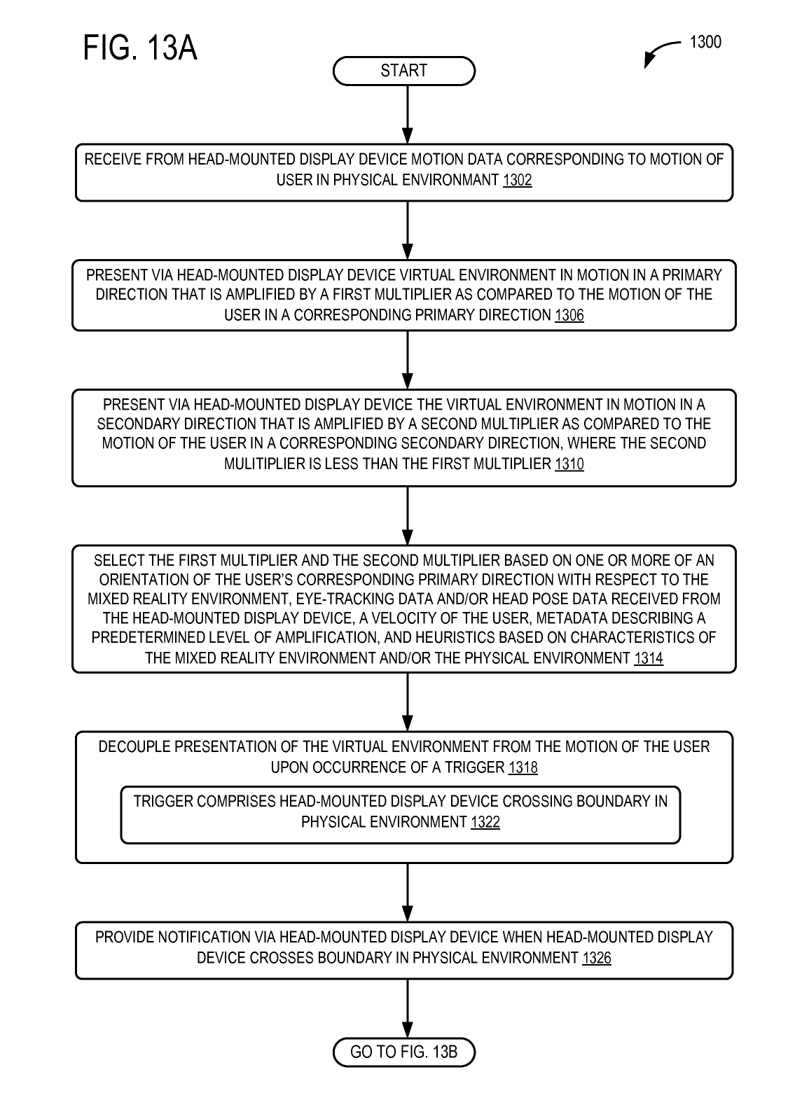

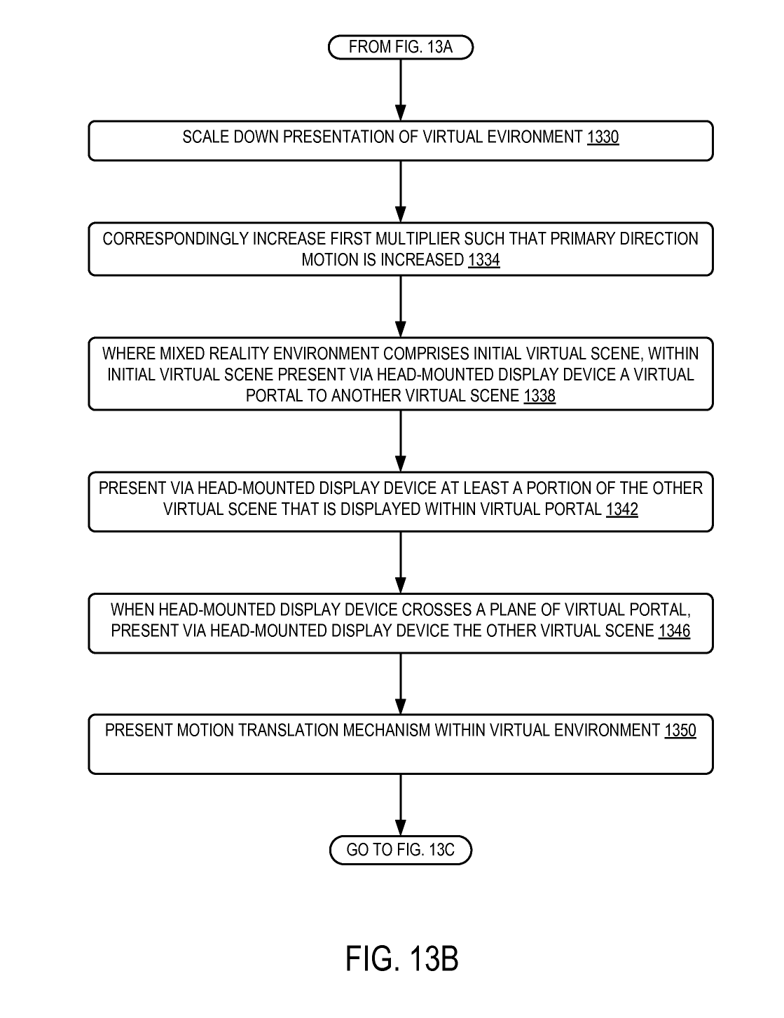

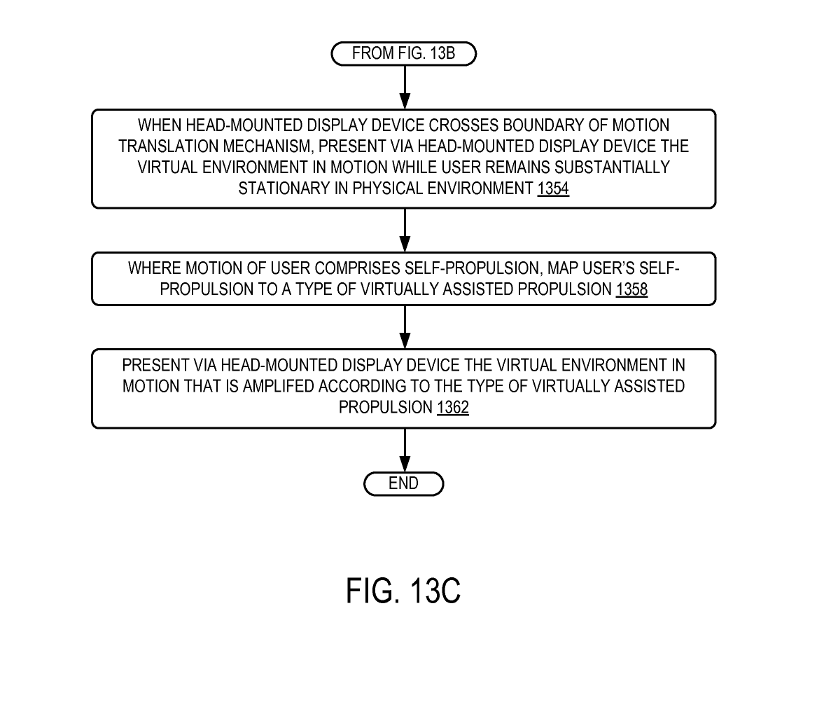

FIGS. 13A, 13B and 13C illustrate a flow chart of a method 1300 for providing motion amplification to a virtual environment in a mixed reality environment according to an embodiment of the present disclosure. The following description of method 1300 is provided with reference to the software and hardware components of the mixed reality augmentation system 10 described above and shown in FIGS. 1-12. It will be appreciated that method 1300 may also be performed in other contexts using other suitable hardware and software components.

With reference to FIG. 13A, at 1302 the method 1300 includes receiving from a head-mounted display device motion data that corresponds to motion of a user in a physical environment. At 1306 the method 1300 includes presenting via the head-mounted display device the virtual environment in motion in a principal direction, with the principal direction motion being amplified by a first multiplier as compared to the motion of the user in a corresponding principal direction. At 1310 the method 1300 includes presenting via the head-mounted display device the virtual environment in motion in a secondary direction, where the secondary direction motion is amplified by a second multiplier as compared to the motion of the user in a corresponding secondary direction, and where the second multiplier is less than the first multiplier.

At 1314 the method 1300 includes selecting the first multiplier and the second multiplier based on one or more of an orientation of the user's corresponding principal direction with respect to the virtual environment, eye-tracking data and/or head pose data received from the head-mounted display device, a velocity of the user, metadata describing a predetermined level of amplification, and heuristics based on characteristics of the virtual environment and/or the physical environment. At 1318 the method 1300 includes decoupling the presentation of the virtual environment from the motion of the user upon the occurrence of a trigger. At 1322 the trigger may comprise the HMD device crossing a boundary in the physical environment.

At 1326 the method 1300 includes providing a notification via the HMD device when the head-mounted display device crosses a boundary in the physical environment. With reference now to FIG. 13B, at 1330 the method 1300 includes scaling down the presentation of the virtual environment, and at 1334 correspondingly increasing the first multiplier such that the principal direction motion is increased. At 1338, where the virtual environment comprises an initial virtual scene, the method 1300 includes presenting within the initial virtual scene and via the HMD device a virtual portal to another virtual scene. At 1342 the method 1300 includes presenting via the HMD device at least a portion of the other virtual scene that is displayed within the virtual portal. At 1346 the method 1300 includes, when the HMD device crosses a plane of the virtual portal, presenting via the HMD device the other virtual scene.

At 1350 the method 1300 includes presenting a motion translation mechanism within the virtual environment. At 1354 the method 1300 includes, when the HMD device crosses a boundary of the motion translation mechanism, presenting via the HMD device the virtual environment in motion while the user remains substantially stationary in the physical environment. At 1358 the method 1300 includes, where the motion of the user comprises self-propulsion, mapping the user's self-propulsion to a type of virtually assisted propulsion. At 1362 the method 1300 includes presenting via the HMD device the virtual environment in motion that is amplified according to the type of virtually assisted propulsion.

In other examples, the virtual environment may be modified to allow a user to naturally navigate around physical objects detected by the HMD device in the user's surroundings. For example, if the user is navigating a virtual cityscape within the confines of a living room space, areas within the virtual cityscape may be cordoned off using, for example, virtual construction or police warning tape. The area bounded by the virtual warning tape may correspond to a couch, table or other physical object in room. In this manner, the user may navigate around the cordoned off objects and thus continue experiencing the mixed reality experience. If the user still navigates through the virtual warning tape, the mixed reality augmentation system 10 may respond by providing a warning notice or other obstacle avoidance response to the user.

It will be appreciated that method 1300 is provided by way of example and is not meant to be limiting. Therefore, it is to be understood that method 1300 may include additional and/or alternative steps than those illustrated in FIGS. 13A, 13B and 13C. Further, it is to be understood that method 1300 may be performed in any suitable order. Further still, it is to be understood that one or more steps may be omitted from method 1300 without departing from the scope of this disclosure.

FIG. 14 schematically shows a nonlimiting embodiment of a computing system 1400 that may perform one or more of the above described methods and processes. Computing device 22 may take the form of computing system 1400. Computing system 1400 is shown in simplified form. It is to be understood that virtually any computer architecture may be used without departing from the scope of this disclosure. In different embodiments, computing system 1400 may take the form of a mainframe computer, server computer, desktop computer, laptop computer, tablet computer, home entertainment computer, network computing device, mobile computing device, mobile communication device, gaming device, etc. As noted above, in some examples the computing system 1400 may be integrated into an HMD device.

As shown in FIG. 14, computing system 1400 includes a logic subsystem 1404 and a storage subsystem 1408. Computing system 1400 may optionally include a display subsystem 1412, a communication subsystem 1416, a sensor subsystem 1420, an input subsystem 1422 and/or other subsystems and components not shown in FIG. 14. Computing system 1400 may also include computer readable media, with the computer readable media including computer readable storage media and computer readable communication media. Computing system 1400 may also optionally include other user input devices such as keyboards, mice, game controllers, and/or touch screens, for example. Further, in some embodiments the methods and processes described herein may be implemented as a computer application, computer service, computer API, computer library, and/or other computer program product in a computing system that includes one or more computers.

Logic subsystem 1404 may include one or more physical devices configured to execute one or more instructions. For example, the logic subsystem 1404 may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The logic subsystem 1404 may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

Storage subsystem 1408 may include one or more physical, persistent devices configured to hold data and/or instructions executable by the logic subsystem 1404 to implement the herein described methods and processes. When such methods and processes are implemented, the state of storage subsystem 1408 may be transformed (e.g., to hold different data).

Storage subsystem 1408 may include removable media and/or built-in devices. Storage subsystem 1408 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Storage subsystem 1408 may include devices with one or more of the following characteristics: volatile, nonvolatile, dynamic, static, read/write, read-only, random access, sequential access, location addressable, file addressable, and content addressable.

In some embodiments, aspects of logic subsystem 1404 and storage subsystem 1408 may be integrated into one or more common devices through which the functionally described herein may be enacted, at least in part. Such hardware-logic components may include field-programmable gate arrays (FPGAs), program- and application-specific integrated circuits (PASIC/ASICs), program- and application-specific standard products (PSSP/ASSPs), system-on-a-chip (SOC) systems, and complex programmable logic devices (CPLDs), for example.

FIG. 14 also shows an aspect of the storage subsystem 1408 in the form of removable computer readable storage media 1424, which may be used to store data and/or instructions executable to implement the methods and processes described herein. Removable computer-readable storage media 1424 may take the form of CDs, DVDs, HD-DVDs, Blu-Ray Discs, EEPROMs, and/or floppy disks, among others.

It is to be appreciated that storage subsystem 1408 includes one or more physical, persistent devices. In contrast, in some embodiments aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be propagated by a pure signal via computer-readable communication media.

When included, display subsystem 1412 may be used to present a visual representation of data held by storage subsystem 1408. As the above described methods and processes change the data held by the storage subsystem 1408, and thus transform the state of the storage subsystem, the state of the display subsystem 1412 may likewise be transformed to visually represent changes in the underlying data. The display subsystem 1412 may include one or more display devices utilizing virtually any type of technology. Such display devices may be combined with logic subsystem 1404 and/or storage subsystem 1408 in a shared enclosure, or such display devices may be peripheral display devices. The display subsystem 1412 may include, for example, the display system 48 and transparent display 44 of the HMD device 36.

When included, communication subsystem 1416 may be configured to communicatively couple computing system 1400 with one or more networks and/or one or more other computing devices. Communication subsystem 1416 may include wired and/or wireless communication devices compatible with one or more different communication protocols. As nonlimiting examples, the communication subsystem 1416 may be configured for communication via a wireless telephone network, a wireless local area network, a wired local area network, a wireless wide area network, a wired wide area network, etc. In some embodiments, the communication subsystem may allow computing system 1400 to send and/or receive messages to and/or from other devices via a network such as the Internet.

Sensor subsystem 1420 may include one or more sensors configured to sense different physical phenomenon (e.g., visible light, infrared light, sound, acceleration, orientation, position, etc.) as described above. Sensor subsystem 1420 may be configured to provide sensor data to logic subsystem 1404, for example. As described above, such data may include eye-tracking information, image information, audio information, ambient lighting information, depth information, position information, motion information, user location information, and/or any other suitable sensor data that may be used to perform the methods and processes described above.

When included, input subsystem 1422 may comprise or interface with one or more sensors or user-input devices such as a game controller, gesture input detection device, voice recognizer, inertial measurement unit, keyboard, mouse, or touch screen. In some embodiments, the input subsystem 1422 may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

The term “program” may be used to describe an aspect of the mixed reality augmentation system 10 that is implemented to perform one or more particular functions. In some cases, such a program may be instantiated via logic subsystem 1404 executing instructions held by storage subsystem 1408. It is to be understood that different programs may be instantiated from the same application, service, code block, object, library, routine, API, function, etc. Likewise, the same program may be instantiated by different applications, services, code blocks, objects, routines, APIs, functions, etc. The term “program” is meant to encompass individual or groups of executable files, data files, libraries, drivers, scripts, database records, etc.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A mixed reality augmentation system for providing motion amplification to a virtual environment in a mixed reality environment, the mixed reality augmentation system comprising:
a head-mounted display device operatively connected to a computing device, the head-mounted display device including a display system for presenting the mixed reality environment; and
a mixed reality augmentation program executed by a processor of the computing device, the mixed reality augmentation program configured to:
receive from the head-mounted display device motion data that corresponds to motion of a user in a physical environment;
present via the display system the virtual environment in motion in a principal direction, the principal direction motion being amplified by a first multiplier as compared to the motion of the user in a corresponding principal direction, and
present via the display system the virtual environment in motion in a secondary direction, the secondary direction motion being amplified by a second multiplier as compared to the motion of the user in a corresponding secondary direction, wherein the second multiplier is less than the first multiplier.

2. The mixed reality augmentation system of claim 1, wherein the mixed reality augmentation program is further configured to select the first multiplier and the second multiplier based on one or more of an orientation of the user's corresponding principal direction with respect to the virtual environment, eye-tracking data and/or head pose data received from the head-mounted display device, a velocity of the user, metadata describing a predetermined level of amplification, and heuristics based on characteristics of the virtual environment and/or the physical environment.

3. The mixed reality augmentation system of claim 1, wherein the mixed reality augmentation program is further configured to decouple the presentation of the virtual environment from the motion of the user upon the occurrence of a trigger.

4. The mixed reality augmentation system of claim 3, wherein the trigger comprises the head-mounted display device crossing a boundary in the physical environment.

5. The mixed reality augmentation system of claim 1, wherein the mixed reality augmentation program is further configured to provide a notification via the head-mounted display device when the head-mounted display device crosses a boundary in the physical environment.

6. The mixed reality augmentation system of claim 1, wherein the mixed reality augmentation program is further configured to:
scale down the presentation of the virtual environment; and
correspondingly increase the first multiplier such that the principal direction motion is increased.

7. The mixed reality augmentation system of claim 1, wherein the virtual environment comprises an initial virtual scene, and the mixed reality augmentation program is further configured to:
within the initial virtual scene present via the display system a virtual portal to another virtual scene;
present via the display system at least a portion of the other virtual scene that is displayed within the virtual portal; and
when the head-mounted display device crosses a plane of the virtual portal, present via the display system the other virtual scene.

8. The mixed reality augmentation system of claim 1, wherein the mixed reality augmentation program is further configured to:
present a motion translation mechanism within the virtual environment; and
when the head-mounted display device crosses a boundary of the motion translation mechanism, present via the display system the virtual environment in motion while the user remains substantially stationary in the physical environment.

9. The mixed reality augmentation system of claim 8, wherein the mixed reality augmentation program is further configured to continue presenting via the display system the virtual environment in motion while user moves within a bounded area of the motion translation mechanism.

10. The mixed reality augmentation system of claim 1, wherein the motion of the user comprises self-propulsion, and the mixed reality augmentation program is further configured to:
map the user's self-propulsion to a type of virtually assisted propulsion; and
present via the display system the virtual environment in motion that is amplified according to the type of virtually assisted propulsion.

11. A method for providing motion amplification to a virtual environment in a mixed reality environment, comprising:
receiving from a head-mounted display device motion data that corresponds to motion of a user in a physical environment;
presenting via the head-mounted display device the virtual environment in motion in a principal direction, the principal direction motion being amplified by a first multiplier as compared to the motion of the user in a corresponding principal direction; and
presenting via the head-mounted display device the virtual environment in motion in a secondary direction, the secondary direction motion being amplified by a second multiplier as compared to the motion of the user in a corresponding secondary direction, wherein the second multiplier is less than the first multiplier.

12. The method of claim 11, further comprising selecting the first multiplier and the second multiplier based on one or more of an orientation of the user's corresponding principal direction with respect to the virtual environment, eye-tracking data and/or head pose data received from the head-mounted display device, a velocity of the user, metadata describing a predetermined level of amplification, and heuristics based on characteristics of the virtual environment and/or the physical environment.

13. The method of claim 11, further comprising decoupling the presentation of the virtual environment from the motion of the user upon the occurrence of a trigger.

14. The method of claim 13, wherein the trigger comprises the head-mounted display device crossing a boundary in the physical environment.

15. The method of claim 11, further comprising providing a notification via the head-mounted display device when the head-mounted display device crosses a boundary in the physical environment.

16. The method of claim 11, further comprising:
scaling down the presentation of the virtual environment; and
correspondingly increasing the first multiplier such that the principal direction motion is increased.

17. The method of claim 11, wherein the virtual environment comprises an initial virtual scene, and further comprising:
within the initial virtual scene presenting via the head-mounted display device a virtual portal to another virtual scene;
presenting via the head-mounted display device at least a portion of the other virtual scene that is displayed within the virtual portal; and
when the head-mounted display device crosses a plane of the virtual portal, presenting via the head-mounted display device the other virtual scene.

18. The method of claim 11, further comprising:
presenting a motion translation mechanism within the virtual environment; and
when the head-mounted display device crosses a boundary of the motion translation mechanism, presenting via the head-mounted display device the virtual environment in motion while the user remains substantially stationary in the physical environment.

19. The method of claim 11, wherein the motion of the user comprises self-propulsion, further comprising:
mapping the user's self-propulsion to a type of virtually assisted propulsion; and
presenting via the head-mounted display device the virtual environment in motion that is amplified according to the type of virtually assisted propulsion.

20. A method for providing motion amplification to a virtual environment in a mixed reality environment, comprising:
receiving from a head-mounted display device motion data that corresponds to motion of a user in a physical environment;
presenting via the head-mounted display device the virtual environment in motion in a principal direction, the principal direction motion being amplified by a first multiplier as compared to the motion of the user in a corresponding principal direction;
presenting via the head-mounted display device the virtual environment in motion in a secondary direction, the secondary direction motion being amplified by a second multiplier as compared to the motion of the user in a corresponding secondary direction, wherein the second multiplier is less than the first multiplier; and
decoupling the presentation of the virtual environment from the motion of the user upon the occurrence of a trigger.
